(19) United States
(12) Patent Application Publication
(10) Pub. No.: US 2004/0112652 A1
(43) Pub. Date: Jun. 17, 2004

(54) Parallel configuration system for hybrid vehicles

(75) Inventors: Giuseppe Esposito Corcione, Marigliano (NA) (IT); Gianguido Rizzotto, Civate (IT); Gianluca Vitale, Guagnano (LE) (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.I., Agrate Brianza (MI) (IT)

(21) Appl. No.: 10/696,723

(22) Filed: Oct. 29, 2003

(30) Foreign Application Priority Data
Oct. 29, 2002 (EP) 02425652.1

(51) Int. Cl. B60K 1/00

(52) U.S. Cl. 180/65.2

(57) ABSTRACT

A parallel configuration system for hybrid propulsion vehicles is provided. The drive thrust is distributed between an electric engine and an internal combustion engine through a transmission system delivering the torque of both engines to the vehicle wheels. The internal combustion engine is a diesel engine operating at steady state at an operation point having the highest efficiency and with the consumption and emissions being reduced.

### FIELD OF THE INVENTION

The present invention relates to a parallel configuration system for hybrid propulsion vehicles. More specifically, the present invention relates to a hybrid propulsion vehicle wherein the drive thrust is distributed between an electric engine and an internal combustion engine through a transmission system delivering the torque of both engines to the vehicle wheels.

### BACKGROUND OF THE INVENTION

The present invention is an improvement of what has been described in European Patent Application No. 01830645.6, which is incorporated herein by reference and is assigned to the current assignee of the present invention. The growing interest shown by the international community for the decrease of air pollutants has led to the issuing of more and more severe regulations concerning automobile vehicle polluting emissions.

In particular, the European Union plans to implement within 2005 severe restrictions on exhaust emissions and fuel consumption of internal combustion engines. The most significant regulations are briefly described below, and some of them are already in force while others are pending:

Euro III (98/69): vehicles registered from Jan. 1, 2001 comply with this directive. Besides the problem of pollutant emission, which is lower than the previous ones, this directive introduces the requirement of an on board auto-diagnostic system OBD (On Board Diagnostic), indicating any malfunction. It is compulsory to do the repair within a determined number of kilometers, otherwise harsh sanctions are applied. These directives, which are valid for gasoline cars, will come into force in 2003 for diesel engines.

Euro IV (98/68 B): it will come into force on Jan. 1, 2005. Euro V (2001/27/EC): it will come into force on Jan. 1, 2008.

The total emission estimate is described in the following TABLE 1, and is calculated by combining technical data (emission factors) and active data (vehicle total kilometers) provided by the user of a vehicle for passenger transport.

TABLE 1

| Tier | Year | CO | HC | HC + NOx | NOx | PM |
|---|---|---|---|---|---|---|
| Diesel | | | | | | |
| Euro 1 | 1992 | 2.72 | — | 0.97 | — | 0.14 |
| Euro 2-IDI | 1996 | 1.0 | — | 0.7 | — | 0.08 |
| Euro 2-DI | 1999 | 1.0 | | 0.9 | — | 0.10 |
| Euro 3 | 2000.01 | 0.64 | — | 0.56 | 0.50 | 0.05 |
| Euro 4 | 2005.01 | 0.50 | — | 0.30 | 0.25 | 0.025 |
| Petrol (Gasoline) | | | | | | |
| Euro 3 | 2000.01 | 2.30 | 0.20 | — | 0.15 | — |
| Euro 4 | 2005.01 | 1.0 | 0.10 | — | 0.08 | — |

Vehicle emissions highly depend on the rotational speed due to the engine use, such as driving in the city, in the country or on a freeway, for example. In the future, compliance with these regulations will involve a considerable effort by car producers in developing low-emission vehicles. In this point of view, hybrid propulsion vehicles will play a leading role in consideration of both the more developed technology and the low emissions, but also of the lower consumption.

The prior art already provides some configurations of hybrid propulsion vehicles, i.e., vehicles equipped with an electric engine and an internal combustion engine. The two conventional hybrid vehicle configurations are the series configuration and the parallel configuration.

In the series configuration the internal combustion engine runs at a peak efficiency steady state to recharge the storage batteries powering the electric engine. Essentially, the engine operates as a generator and it is sized according to the drive-demanded average power.

It is evident that this power value is considerably lower than the highest deliverable power. Therefore, under such conditions, the internal combustion engine operates at a torque curve point having the highest efficiency and wherein polluting emissions are reduced to a minimum.

In this configuration, the electric machine mounted in a vehicle runs mainly as an engine, and runs as a generator only during the regenerative braking steps. The electric machine rating must be equal to the vehicle rating, since the drive demanded power is supplied only by the electric engine.

The drawbacks of this configuration are represented by the batteries which, having to be sized according to the electric machine rating, will be characterized by considerable size and weight, negatively affecting the vehicle performances. FIG. 1 shows in schematic blocks the structure of a hybrid propulsion vehicle of the previously described series type.

In the parallel configuration the internal combustion engine runs dynamically (not at a fixed point) and it contributes, together with the electric drive, to supply the required mechanical power. Generally, the internal combustion and electric engine contributions are delivered to the wheel axis through a torque conversion mechanical coupling.

The total vehicle power is thus distributed between the electric engine and the internal combustion engine. Therefore, the latter power is lower than the one of a conventional vehicle engine, in consideration also of the possible electric machine overload.

The efficiency and the polluting emissions are optimized through an adequate control of the radiant flux distribution among the main components. The electric engine has a limited power and it operates also as a generator to recharge the batteries. The batteries have a reduced size and weight since they power a reduced power electric engine. FIG. 2 shows in schematic blocks the structure of a parallel-type hybrid propulsion vehicle.

Both of the above described series/parallel configurations have advantages and disadvantages. In the series configuration hybrid system the internal combustion engine only functions for the battery charge, therefore the high energy density of fossil fuels cannot be exploited. Moreover, the high weight of the storage batteries causes a considerable increase in the vehicle inertia and this damages the equal-power performances.

Also, the need to use two different electric machines, the one for the drive and the other for the storage battery recharge, increases the system complexity to the detriment of reliability. On the contrary, in the parallel configuration hybrid system, the internal combustion engine is drive-operating, and having to follow driving dynamics, has a highly variable operating condition involving higher consumption and higher polluting emissions.

The pollutants produced by an internal combustion (IC) engine result from an incomplete combustion process between the fuel/air mixture, or from reactions of other components in the combustion chamber, such as for the combustion of oil or oil additives or the combustion of inorganic components like sulphur when gas oil is used.

The main problem of the gasoline engine is the emission of nitrogen and carbon compounds like Noₓ and CO₂. In diesel engines, besides nitrogen compound Noₓ emission, carbon is emitted in the form of DPM (Diesel Particulate Matter) particulates which are present in gasoline engines in negligible quantities.

The main cause of nitrogen compound Noₓ formation, both in diesel and gasoline engines, is the fact of reaching such a high temperature in the combustion chamber which causes the dissociation of air nitrogen and the recombination thereof with the oxygen, with the subsequent nitric oxide NO and nitrogen dioxide NO₂ formation.

### SUMMARY OF THE INVENTION

The technical problem underlying the present invention is to provide a parallel configuration hybrid system having structural and functional characteristics that overcome the limits of the approaches discussed above by sharing the advantages of both series/parallel configurations but without inheriting the disadvantages thereof.

The idea underlying the present invention is to use a parallel configuration system, but wherein the internal combustion engine operates at a steady state.

Based on this solutive idea the technical problem is solved by a parallel configuration system for hybrid propulsion vehicles as previously described and defined by the characterizing part of claim 1.

### BRIEF DESCRIPTION OF THE DRAWINGS

The features and advantages of the parallel hybrid system according to the invention will be apparent from the following description of an embodiment thereof given by way of a non-limiting example with reference to the attached drawings. In the drawings:

FIG. 1 is a block diagram of a vehicle equipped with a series configuration hybrid propulsion system according to the prior art;

FIG. 2 is a block diagram of a vehicle equipped with a parallel configuration hybrid propulsion system according to the prior art;

FIG. 3 is a block diagram of a vehicle equipped with a parallel configuration hybrid propulsion system according to the present invention;

FIG. 4 is a perspective view of the parallel configuration hybrid propulsion vehicle shown in FIG. 3;

FIG. 5 is a block diagram of the torque control and distribution system according to the present invention;

FIG. 6 is a detailed block diagram of the torque control and distribution system as shown in FIG. 5;

FIG. 7 is a diagram illustrating in greater detail a portion of the torque control and distribution system as shown in FIG. 5; and

FIG. 8 is a graph of torque versus temperature for an example of the hybrid propulsion system operating according to the present invention.

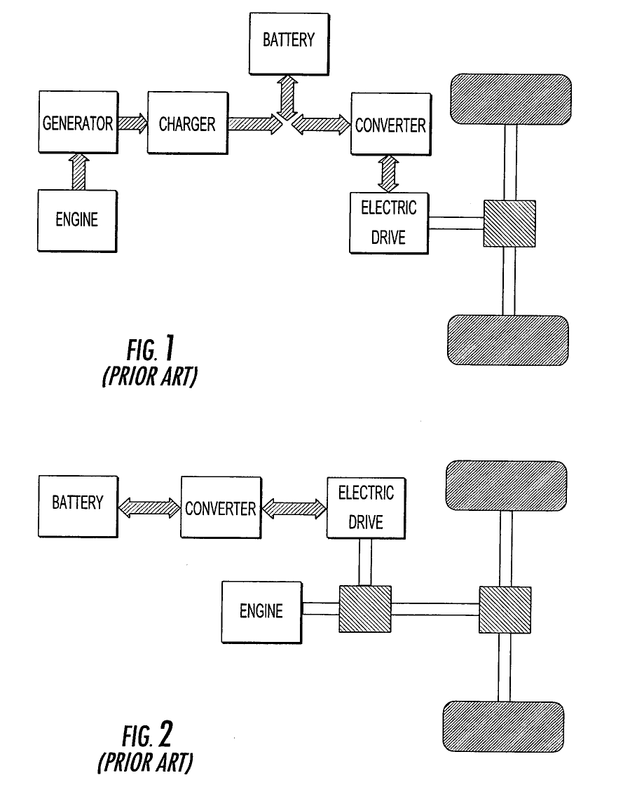

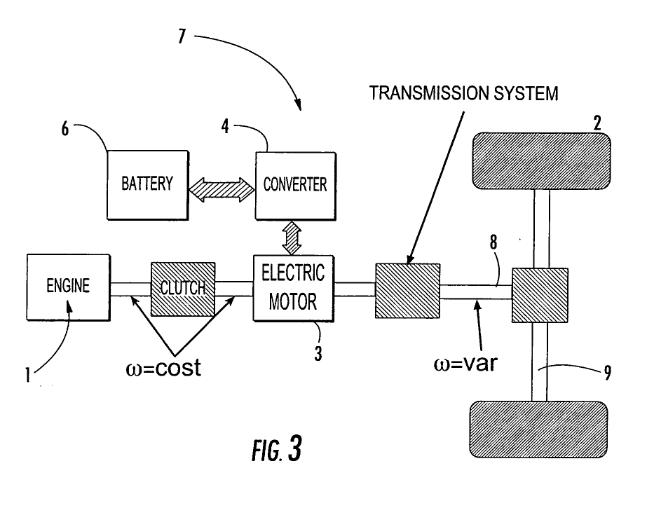

### DETAILED DESCRIPTION OF THE PREFERRED EMBODIMENTS

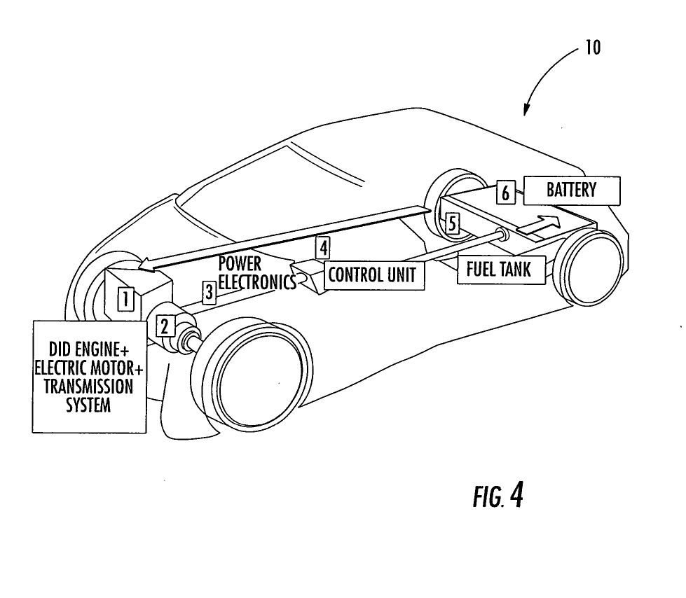

With reference to the drawings, and particularly to the examples of FIGS. 3 and 4, a vehicle 10 equipped with a parallel configuration hybrid propulsion system 7 will now be described. The electronic torque control and distribution system 11 formed according to the present invention is applied to the vehicle 10. Advantageously, the hybrid configuration of FIG. 3 is capable of combining the advantages of the two main types (series and parallel) of hybrid vehicles, as a result of an innovative management of radiant fluxes.

From a classification point of view, the configuration according to the present invention can be incorporated in the parallel hybrid system types, in terms of both performance and size. In fact, as shown in FIG. 4, the vehicle 10 comprises an electric engine 3 which is drive assisted by an internal combustion engine 1. The internal combustion engine 1 is fuel fed by a tank 5 conventionally provided in the vehicle 1. Similarly, the electric engine 3 is powered by storage batteries 6.

In FIG. 4 the tank 5 and the batteries 6 are positioned near the vehicle's 10 rear axle. This positioning is for illustrative purposes, and other locations within the vehicle 10 may be used. Similarly, the engine 1 and the electric engine 3 are shown near the vehicle's 10 front axle. This positioning is also for illustrative purposes, and other locations with in the vehicle may be used. The front axle is shown in the example of FIG. 3 because this arrangement has been preferred to ensure a proper balance distribution in the vehicle 10.

Advantageously, the internal combustion engine 1 is sized on a power value lower than the known parallel hybrid systems. This reduced dimension also concerns the storage batteries 6. This results in a reduction in the vehicle 10 mass, which benefits performance.

In conventional parallel configurations, the combustion engine has a variable operating condition strictly linked to the driving dynamics, thus negatively affecting the consumption and emission levels. On the contrary, this problem cannot be noticed in the series configuration and it is solved by using the steady (angular and torque) state internal combustion engine, at an operation point having the highest efficiency. This is where the consumption and emissions are reduced to a minimum.

Advantageously, to obtain high efficiency and high torque at low speed, the choice of the engine 1 rests on a direct injection diesel engine associated with an electronic control unit 4 for adjusting the injection thereof, for example as described in the above referenced European patent application. Other types of internal combustion engine may be used, such as a common rail-type diesel engine for example. The control unit 4 is incorporated in the control system 11.

To couple the axis 8 of the angular steady state engine 1 with the wheel axis 9, having instead a variable angular speed according to driving conditions, it has been performed through a continuously variable reduction ratio transmission system or group 2.

The diesel engine 1 delivers, therefore, a constant power, adjusted to a driver demanded average power. The control unit 4 manages the operation as a generator or as a draft gear of the internal combustion engine 1, depending on whether the required mechanical power is lower or higher than the power delivered by the diesel engine 1. The control unit 4 also controls the power fluxes to be distributed among the main components (electric machine, diesel engine and storage batteries) to optimize the overall energetic efficiency of the whole system.

As mentioned above, the torque control and distribution system 11 is incorporated in the control unit 4. This control system 11 allows the advantages of the two main types of hybrid vehicles, series and parallel, to be combined due to an innovative management of the radiant fluxes.

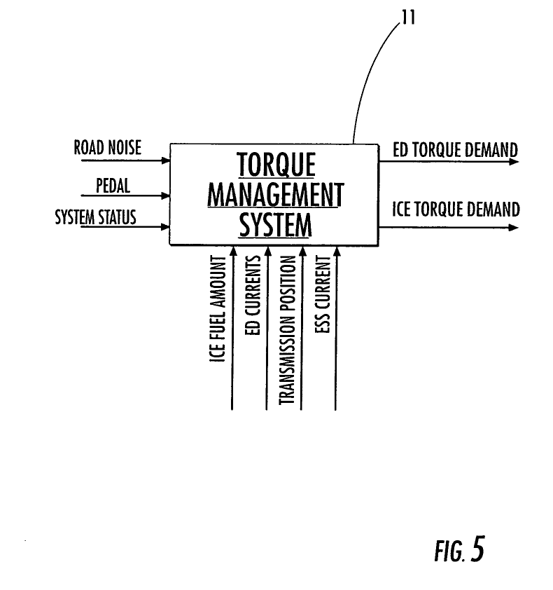

The control system 11 represented in FIG. 5 is based on soft computing techniques and processes the electric signals received on the following inputs: path profiles (road noise); driving commands (pedals); system component status (system status); fuel mass capacity (ICE fuel amount); electric drive phase currents (ED currents); battery-supplied current (ESS currents); transmission system status (transmission position).

The control system 11 calculates the torque contributions of the two engines 1 and 3 taking into account the inputs and obtains at the same time the following parametric information: system status, external requests and noises. It is possible to obtain from these parameters an estimate allowing the operation of the system 11 itself to be optimized.

It is important to note that the system 11 operates also in a predictive way since the estimates are performed by monitoring the present system status but also by interpreting the past history thereof. This is possible due to the presence in the system 11 of a processor incorporating a fuzzy logic operating controller 12. The peculiar structure of fuzzy logic processors, which incorporate a nonvolatile memory comprising data and references to the processing already performed, allows estimate curves of the electric signals needed to drive the hybrid propulsion system to be obtained.

In other words, with the system 11 it is possible to predict the driving style by interpreting at predetermined time intervals the driving cycle already covered. By way of straightforward embodiment, a possible situation which might happen in using the above mentioned vehicle 10 will be analyzed below. In this example the control is applied to the parallel configuration hybrid vehicle 10 wherein the torque to be delivered by the electric machine 3 is obtained by the driver demanded torque less the diesel engine torque.

The control system 11 core manages the torque delivered by the internal combustion engine 1. In this example a fuzzy-type controller 12 is used, for example of the type commercially known as WARP III, whose inputs are the battery state-of-charge (soc) and the index cycle, indicating a path calculated by the average and the variance of the vehicle speed. The variable cycle is recalculated at each predetermined time interval Δt. Moreover, a further variable time makes the output change slow at will.

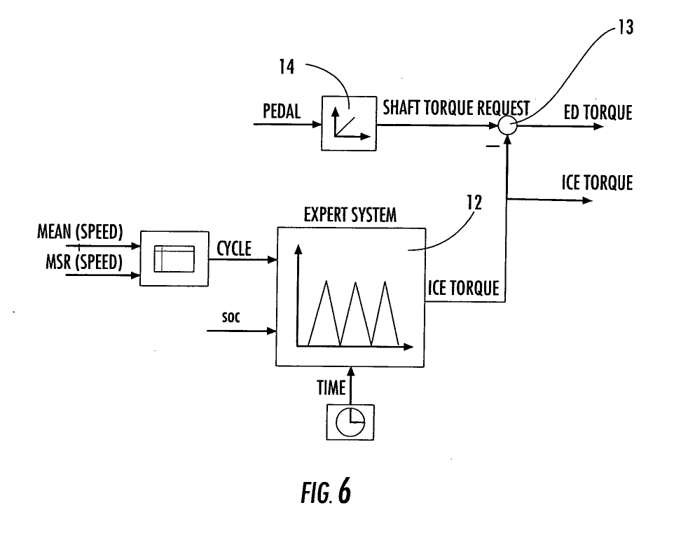

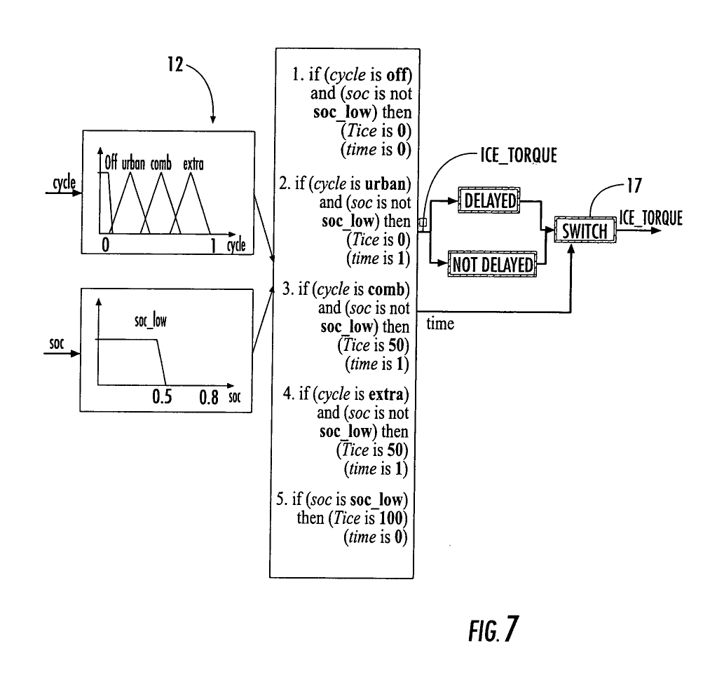

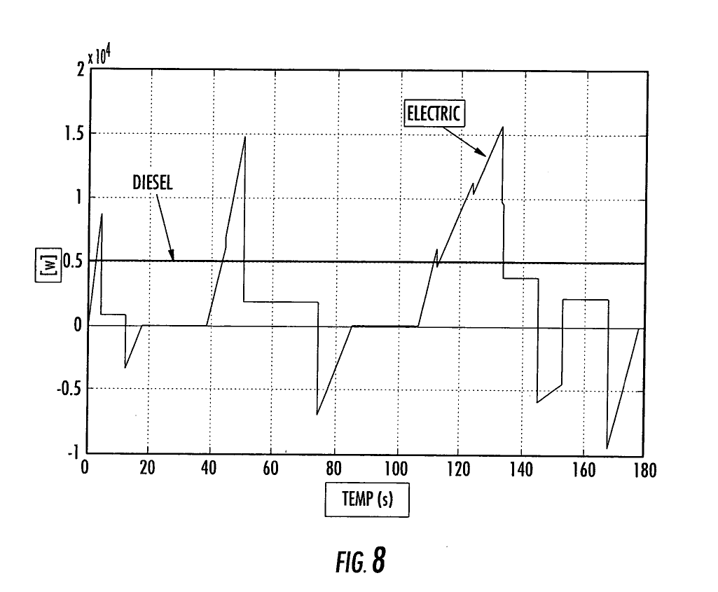

FIG. 6 schematically shows the input signal processor incorporating the controller 12 with the relevant inputs and the output addressed to an adder node 13. The output of a processing block 14 of the signal comes from the accelerator pedal also converging thereto.

As is well known by those skilled in the art, the fuzzy controller 12 operates on so-called membership functions associated with the inputs. The fuzzy interference rules which can be applied by way of example to the membership functions are as follows:

1. if (cycle is off) and (soc is not soc_low) then (Tice is 0) (time is 0);

2. if (cycle is urban) and (soc is not soc_low) then (Tice is 0) (time is 1);

3. if (cycle is comb) and (soc is not soc_low) then (Tice is 50) (time is 1);

4. if (cycle is extra) and (soc is not soc_low) then (Tice is 50) (time is 1); and

5. if (soc is soc_low) then (Tice is 100) (time is 0).

In this embodiment, the diesel engine 1 runs at a fixed speed and the power delivered therefrom is steady. The control system 11 therefore acts so that the sum of the mechanical power delivered by the diesel engine 1 and the power delivered by the electric engine 3 is always equal to the driver demanded power.

This means that if the power delivered by the diesel engine 1 is higher than the required mechanical power, the electric machine 3 will operate as a generator, recovering and storing the excessive power in the batteries 6. If, on the contrary, the diesel engine 1 power is lower than the required power, the electric machine 3 will provide the remaining part consistently with the capacity of the batteries 6.

As far as batteries 6 are concerned, it is worth noting that, not having to function in this parallel hybrid configuration as a real energy supply, but rather as a buffer in powering the electric engine 3 to reach the drive requested power peaks, batteries having high specific power values and low specific energy values can be conveniently used. For example, batteries incorporating metallic nickel-hydrides can be suitable to this purpose having low specific power values related to the weight unit. This procedure allows masses to be contained, and accordingly, performances to be improved for the same installed power.

Moreover, it must be taken into account that the internal combustion engine 1 can always be excluded by the vehicle clutch, but also turned off under those conditions not requiring a high average power. These conditions include being stopped at traffic lights or driving in limited traffic urban areas, etc. This allows the undesirable fuel consumption to be eliminated, and accordingly, the polluting emissions to be reduced and the overall efficiency to be increased.

Depending on the control system 11, decisions will be corresponding to actions on the vehicle. More particularly, a series of actuators for the main control elements of the vehicle 10, like the clutch, the transmission system, etc., are slaved to the corresponding control system 11 outputs.

FIG. 7 illustrates this control by showing how the fuzzy controller 12 is capable of processing in fuzzy logic the input signals to output a control signal ICE_Torque to be applied to a predetermined actuator of the vehicle 10 through a controlled switch 15.

The presence of the switch 15 allows a predetermined time delay to be applied to the signal ICE_Torque according to necessity and in consideration of the timing signal time. For example, if the control system 11 delivers a signal ICE_Torque=0, the first macroscopic effect on the vehicle control will be the clutch disengagement and the subsequent decoupling of the internal combustion engine 1.

Moreover, if the variable time, which can have logic values 0 and 1, shows that the calculated torque value ICE_torque must be imposed to the torque control, or conveniently delayed to avoid abrupt transients, the switch 15 will provide for the switch of the conduction path through which the signal ICE_torque passes.

The structure of the transmission system 2 will now be discussed in greater detail. The transmission system 2 comprises a continuously variable reduction ratio coupling, called continuously variable. The continuously variable transmission is less complex than a traditional automatic transmission equipped with a torque converter.

The system 2 delivers the torque through a converter comprising a segmented steel belt connecting the engine to the transmission by rotating on expanding pulleys. The ratios change according to the changes imposed to the pulley diameter by an hydraulic system associated thereto. The control of this transmission is entirely electronic and allows, therefore, the engine speed to be kept steady, when the wheel speed is variable.

The above described parallel hybrid configuration has the advantage, if compared to the traditional configurations, to combine the advantages of the two hybrid vehicle base configurations, allowing the diesel engine 1 to operate at a steady state as in the series configuration, while having however two different drive engines as in the parallel configuration. Moreover, the optimum definition of the torque distribution through soft computing techniques allows the system overall efficiency to be considerably improved and emissions reduced.

That which is claimed is:

1. A parallel-configuration system (7) for hybrid propulsion vehicles (10) wherein the drive thrust is distributed between an electric engine (3) and an internal combustion engine (1) through a transmission system (2) delivering the torque of both engines (1, 3) to the vehicle wheels, characterized in that the internal combustion engine (1) operates at steady state.

2. A system according to claim 1, characterized in that the internal combustion engine (1) is a common-rail diesel engine.

3. A system according to claim 1, characterized in that the internal combustion engine (1) operates at an operation point having the highest efficiency and wherein consumption and emissions are reduced to a minimum.

4. A system according to claim 1, characterized in that said transmission system (2) has a continuously variable reduction ratio.

5. A system according to claim 4, characterized in that the transmission system (2) comprises a belt converter rotating on expanding pulleys.

6. A system according to claim 5, characterized in that said belt is metallic and segmented.

7. A system according to claim 5, characterized in that the diameter of said pulleys is automatically varied by an hydraulic system associated to the transmission system and driven by a control unit.

8. A system according to claim 1, characterized in that a control unit (4) manages the internal combustion engine torque distribution for the drive and for the recharge of the power batteries (6) of the electric engine supply (3).

9. A system according to claim 8, characterized in that said electronic control unit (4).
